(19) United States
(12) Patent Application Publication
(10) Pub. No.: US 2026/0233489 A1
(43) Pub. Date: Aug. 13, 2026

(54) LAMINATED STRUCTURE AND METHOD FOR MANUFACTURING LAMINATED STRUCTURE

(71) Applicant: TOMOEGAWA CORPORATION, Tokyo (JP)

(72) Inventors: Takaaki SHIMA, Shizuoka-shi, Shizuoka (JP); Michimasa ITO, Shizuoka-shi, Shizuoka (JP)

(21) Appl. No.: 19/161,271

(22) PCT Filed: Feb. 21, 2024
(86) PCT No.: PCT/JP2024/006402

§ 371 Date: Aug. 31, 2025

(30) Foreign Application Priority Data
Mar. 2, 2023 (JP) 2023-032259

(51) Int. Cl. B32B 3/26; B32B 15/08; B32B 15/20

(52) U.S. Cl. CPC B32B 3/266; B32B 15/08; B32B 15/20; B32B 2250/42; B32B 2307/206; B32B 2307/7375; B32B 2311/12; B32B 2457/00

(57) ABSTRACT

To suppress a short circuit between adjacent metal foils with an insulating layer interposed therebetween in a laminated structure in which the metal foil and the insulating layer are alternately laminated. A laminated structure 10 according to an aspect of the present invention has a structure in which two or more layers of a laminated body 20 are laminated. The laminated body 20 includes a metal foil 22 and an insulating layer 24 laminated on one main surface of the metal foil 22. In the laminated structure 10, the metal foil 22 and the insulating layer 24 are alternately laminated. Assuming that adjacent laminated bodies 20 constituting the laminated structure 10 are a laminated body 20A and a laminated body 20B in order from a lower portion to an upper portion, the laminated body 20A has an insulating layer 24a located at the lower portion and a metal foil 22a located at the upper portion, and the laminated body 20B has an insulating layer 24b located at the lower portion and a metal foil 22b located at the upper portion, a cutout is formed at least at one end portion of the laminated body 20A.

### TECHNICAL FIELD

The present invention relates to a laminated structure and a method for manufacturing the laminated structure.

### BACKGROUND ART

As an electronic component, a laminated structure in which a metal foil and an insulating layer are alternately laminated is known. As this type of laminated structure, for example, there is a laminated coil used for a noise filter such as a low-pass filter or a high-pass filter (see Patent Literature 1).

### CITATION LIST

### Patent Literature

Patent Literature 1: JP H06-231938 A

### SUMMARY OF INVENTION

### Technical Problem

The laminated coil as in Patent Literature 1 has a problem that a short circuit is likely to occur between adjacent metal foils with an insulating layer interposed therebetween.

The present invention has been made in view of the above problem, and an object of the present invention is to provide a technique capable of suppressing a short circuit between adjacent metal foils with an insulating layer interposed therebetween in a laminated structure in which the metal foil and the insulating layer are alternately laminated.

### Solution to Problem

One aspect of the present invention is a laminated structure. The laminated structure is a laminated structure in which two or more layers of a laminated body are laminated, in which the laminated body includes a metal foil and an insulating layer laminated on one main surface of the metal foil, the metal foil and the insulating layer are alternately laminated in the laminated structure, and assuming that adjacent laminated bodies constituting the laminated structure are a laminated body A and a laminated body B in order from a lower portion to an upper portion, the laminated body A has an insulating layer a located at the lower portion and a metal foil a located at the upper portion, and the laminated body B has an insulating layer b located at the lower portion and a metal foil b located at the upper portion, a cutout is formed at least at one end portion of the laminated body A.

In the laminated structure of the above aspect, a length ratio that is a ratio of a horizontal length of a horizontal direction end region to a vertical length of a vertical direction end region of the cutout may be 0.4 to 10.

The horizontal length of the horizontal direction end region may be 1 μm to 200 μm, and the vertical length of the vertical direction end region may be 1 μm to 400 μm.

The cutout may be formed only in the metal foil a.

The cutout may be formed only in the metal foil a and the insulating layer a.

The laminated body may have a strip shape.

A coil shape in which the laminated body is wound may be provided.

The laminated structure of the above aspect may be used for a noise filter.

Another aspect of the present invention is a method for manufacturing a laminated structure. The method for manufacturing the laminated structure includes: a laminated sheet production step of producing a laminated sheet by laminating an insulating layer on one main surface of a metal foil: a laminated body production step of producing a laminated body in which a cutout is formed at a laminated sheet cut end portion by cutting the laminated sheet using a cutting blade having a blade edge angle of 20° to 60°; and a laminated structure production step of producing a laminated structure by laminating the laminated body such that the metal foil and the insulating layer are staggered.

In the method for manufacturing the laminated structure of the above aspect, the laminated body may have a strip shape, and the laminated body may be laminated while being wound in the laminated structure production step.

### Advantageous Effects of Invention

According to the present invention, in a laminated structure in which a metal foil and an insulating layer are alternately laminated, a short circuit between adjacent metal foils with the insulating layer interposed therebetween can be suppressed.

### BRIEF DESCRIPTION OF DRAWINGS

FIG. 1 is a schematic cross-sectional view illustrating a schematic configuration of a laminated structure according to an embodiment.

FIG. 2 is a partial cross-sectional view of the laminated structure according to the embodiment.

FIGS. 3(a) and 3(b) are a plan view of a laminated body and a perspective view of the laminated body in one aspect of the laminated structure according to the embodiment, respectively.

FIG. 4 is a schematic view in a case where the laminated structure according to the embodiment has a coil-shaped structure.

FIG. 5 is a schematic cross-sectional view of a cutting blade used in a laminated body production step.

FIGS. 6(a) to 6(d) are schematic process diagrams showing the laminated body production step.

FIGS. 7(a) to 7(d) are schematic process diagrams showing a laminated structure production step.

### DESCRIPTION OF EMBODIMENTS

Hereinafter, embodiments of the present invention will be described in detail. Note that, in the present specification, a notation “a to b” in description of a numerical range represents a or more and b or less unless otherwise specified.

### (Laminated Structure)

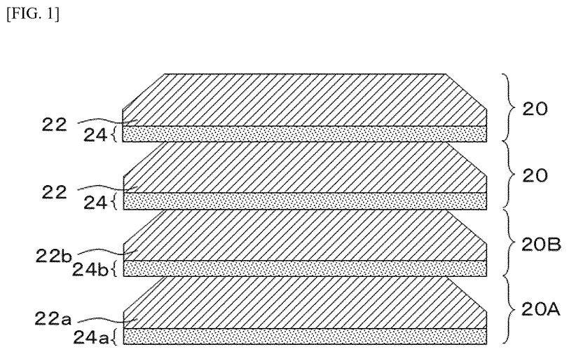

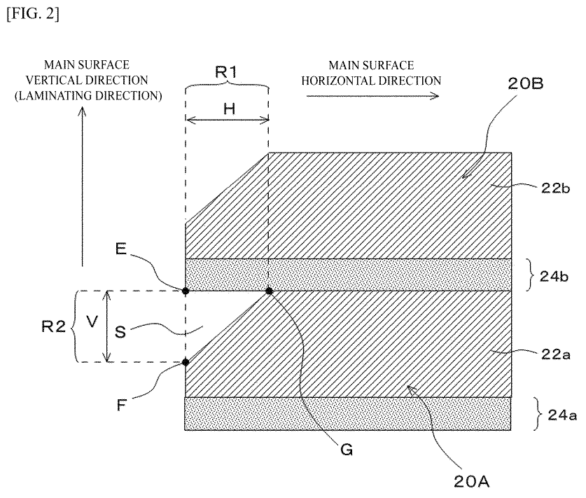

FIG. 1 is a schematic cross-sectional view illustrating a schematic configuration of a laminated structure 10 according to an embodiment. FIG. 2 is a partial cross-sectional view of the laminated structure 10 according to the embodiment.

The laminated structure 10 is formed by laminating two or more layers of a laminated body 20. Each of the laminated bodies 20 constituting the laminated structure 10 includes a metal foil 22 and an insulating layer 24.

Materials constituting each of the laminated bodies 20 may be different in each of the laminated bodies 20, but are preferably the same material from the viewpoint of characteristics and cost.

In the present embodiment, in the laminated structure 10, the metal foil 22 and the insulating layer 24 are laminated alternately. Although not illustrated, an adhesive layer can be provided as a constituent member of the insulating layer 24 for the purpose of sufficiently bonding the metal foil 22 and the insulating layer 24. The adhesive layer may be a constituent member of all the insulating layers 24 inherent in the laminated structure 10, or may be a constituent member of some of the insulating layers 24.

Note that, in FIG. 1, in order to make the following description easy to understand, two laminated bodies 20 adjacent in a direction perpendicular to a main surface of the laminated structure 10 (hereinafter may be simply referred to as a “main surface vertical direction”) are distinguished for convenience as a laminated body 20A and a laminated body 20B. Further, constituent members of the laminated body 20A are a metal foil 22a and an insulating layer 24a. In addition, constituent members of the laminated body 20B are a metal foil 22b and an insulating layer 24b.

Description of these reference numerals also applies to FIG. 2.

In other words, the two laminated bodies 20 adjacent in the vertical direction in the laminated structure 10 are referred to as the laminated body 20A and the laminated body 20B in order from a lower portion to an upper portion in the main surface vertical direction. The laminated body 20A has the insulating layer 24a located at the lower portion in the main surface vertical direction and the metal foil 22a located at the upper portion in the direction. In addition, the laminated body 20B has the insulating layer 24b located at the lower portion in the main surface vertical direction and the metal foil 22b located at the upper portion in the direction.

### (Metal Foil)

Examples of a material of the metal foil 22 include copper, aluminum, stainless steel, nickel, titanium, zinc, tin, gold, silver, platinum, and alloys thereof. When the copper is used as the material of the metal foil 22, it is desirable to have a form of a rolled copper foil having excellent flexibility.

A thickness of the metal foil 22 is preferably 1 μm to 200 μm, more preferably 1 μm to 100 μm, and still more preferably 10 μm to 80 μm from the viewpoint of workability.

### (Insulating Layer)

The insulating layer 24 includes at least an insulating main member, and an adhesive layer can be provided as a constituent member on one main surface or both main surfaces of the insulating main member. That is, the insulating layer 24 includes not only a single layer but also a multilayer structure.

A material of the insulating main member is preferably a material having excellent insulation properties and good workability. In addition to resins such as a polyimide resin, an epoxy resin, a benzocyclobutene resin, and a fluororesin, glass made of SiO₂ or the like, a glass fiber cloth, glass ceramics, a mixture of these materials, and the like, Ni—Zn-based ferrite and the like are used. In the present embodiment, the polyimide resin is preferably used from the viewpoint of workability.

When the polyimide resin or the like is used as the insulating main member, the insulating layer may have water supply properties, which may lower reliability of the laminated structure 10. Therefore, a moisture-proof agent (for example, a resin or wax) may be impregnated into the polyimide resin or the like.

A thickness of the insulating layer 24 is preferably 1 μm to 200 μm, more preferably 1 μm to 100 μm, and still more preferably 1 μm to 50 μm from the viewpoint of ensuring insulation between two metal foils 22 adjacent to each other with the insulating layer 24 interposed therebetween in the laminated structure 10 and workability.

As described above, the insulating layer 24 can be provided with the adhesive layer as the constituent member. The adhesive layer can be provided on one main surface or both main surfaces of the insulating main member.

A material of the adhesive layer is not particularly limited as long as it has a sufficient adhesive force with respect to the insulating main member and the metal foil 22, and examples thereof include an acrylic adhesive, a urethane-based adhesive, and an epoxy-based adhesive.

A thickness of each of the adhesive layers is preferably 1 μm to 200 μm, more preferably 1 μm to 100 μm, and still more preferably 1 μm to 50 μm from the viewpoint of workability and prevention of protrusion of the adhesive layer.

The adhesive layer can be formed, for example, by applying a predetermined amount of an adhesive composition to one main surface or both main surfaces of the insulating main member, and then drying the adhesive composition.

As illustrated in FIG. 2, a cutout (in an example illustrated in FIG. 2, a triangular region S having a point E, a point F, and a point G as vertices) is formed in the metal foil 22a at least at one end portion of the metal foil 22a of the laminated body 20A. Due to this cutout, the metal foil 22a is not in contact with a horizontal direction end region (R1 illustrated in FIG. 2) in a main surface of the laminated body 20B on the insulating layer 24b side.

In the present embodiment, in two laminated bodies 20A and 20B vertically adjacent to each other in the main surface vertical direction (laminating direction) in the laminated structure 10, the metal foil 22a of the laminated body 20A positioned at the lower portion in the main surface vertical direction has at least a cutout.

In addition, the horizontal direction end region R1 is, in other words, a region from an exposed outermost portion (the point E illustrated in FIG. 2) of the insulating layer 24b to an exposed innermost portion (the point G illustrated in FIG. 2, or referred to as a cutout innermost portion) of the insulating layer 24b in a direction (horizontal direction) parallel to the main surfaces of the insulating layers 24a and 24b constituting the laminated structure 10.

A horizontal length H of the horizontal direction end region is preferably 1 μm to 200 μm, more preferably 1 μm to 150 μm, and still more preferably 1 μm to 100 μm from the viewpoint of sufficiently obtaining end strength of the laminated structure 10.

In the example illustrated in FIG. 2, the cutout has a tapered straight line in a region connecting the point F to the point G on an end portion end surface of the metal foil 22a, but a line connecting the point F to the point G is not particularly limited, and may be curved, bent, or a mixture thereof.

In addition, the cutout may be provided not only at the location of the metal foil 22 of the laminated body 20 but also partially in the insulating layer 24. In this case, for example, when expressed using reference numerals of FIG. 2, the end point F starting from the point G illustrated in FIG. 2 exists in the insulating layer 24a.

At this time, the cutout is formed in the metal foil 22a and the insulating layer 24a at one common end portion of the metal foil 22a and the insulating layer 24a of the laminated body 20A. Due to this cutout, the metal foil 22a is not in contact with the horizontal direction end region R1 in the main surface of the laminated body 20B on the insulating layer 24b side.

Therefore, in the present embodiment, for the two laminated bodies 20A and 20B vertically adjacent to each other in the main surface vertical direction in the laminated structure 10, the metal foil 22a of the laminated body 20A positioned at the lower portion in the main surface vertical direction has at least the cutout, but the insulating layer 24a of the laminated body 20A may have the cutout. The presence or absence of the cutout of the insulating layer 24 of the laminated body 20 is not particularly limited, and among the laminated bodies 20 in the laminated structure 10, the insulating layers 24 of some laminated bodies 20 may have the cutout, the insulating layers 24 of all the laminated bodies 20 may have the cutout, or the insulating layers 24 of all the laminated bodies 20 may not have the cutout.

As shown in FIG. 2, in the laminating direction (vertical direction) of the two laminated bodies 20A and 20B vertically adjacent to each other in the main surface vertical direction in the laminated structure 10, a length V of a vertical direction end region (R2 shown in FIG. 2) which is a region from the exposed outermost portion of the insulating layer 24b of the laminated body 20B located at the upper portion in the main surface vertical direction to a cutout outermost portion of the metal foil 22a or the insulating layer 24a of the laminated body 20A located at the lower portion in the main surface vertical direction (the point F of the metal foil 22a in the example shown in FIG. 2, but in a case where the cutout is formed in the metal foil 22a and the insulating layer 24a of the laminated body 20A described above, the cutout outermost portion exists in the insulating layer 24a) is preferably 1 μm to 400 μm, more preferably 1 μm to 300 μm, still more preferably 1 μm to 200 μm, and particularly preferably 1 μm to 100 μm from the viewpoint of sufficiently obtaining the end strength of the laminated structure 10.

Here, in the present embodiment, a length ratio which is a ratio between the horizontal length H of the horizontal direction end region R1 and the vertical length V of the vertical direction end region (hereinafter may be referred to as H/V) is preferably 0.4 to 10 and more preferably 0.4 to 5. By the above-described length ratio (H/V), it is possible to suppress occurrence of an electrical short circuit in the two laminated bodies 20 vertically adjacent to each other in the main surface vertical direction in the laminated structure 10.

The laminated structure 10 according to the present embodiment has the above-described cutout, but in a case where the laminated structure 10 has a plurality of cutouts, cutout shapes may be the same as or different from each other.

In addition, in the laminated structure 10 according to the present embodiment, in the two laminated bodies 20A and 20B vertically adjacent to each other in the main surface vertical direction in the laminated structure 10, a shape protruding to the upper laminated body 20B in the main surface vertical direction, that is, a so-called burr is not substantially formed at the cutout outermost portion of the metal foil 22a or the insulating layer 24a of the lower laminated body 20A in the main surface vertical direction. As a result, it is possible to further suppress occurrence of an electrical short circuit between the two laminated body 20A and 20B vertically adjacent to each other in the main surface vertical direction in the laminated structure 10.

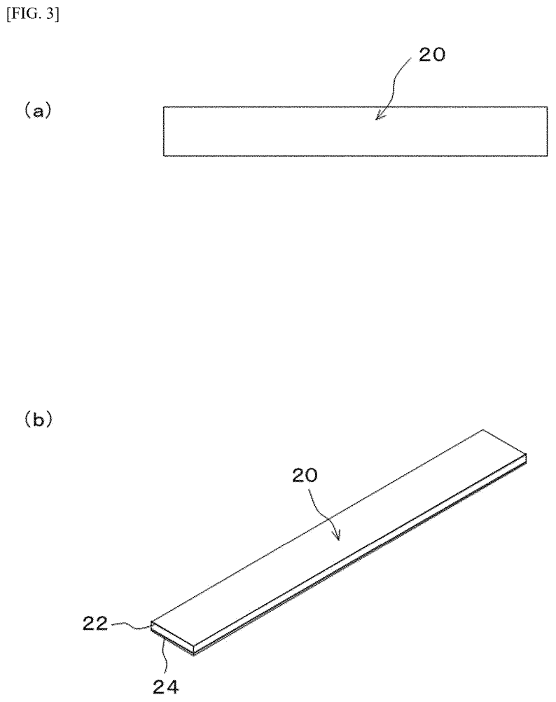

FIGS. 3(a) and 3(b) are a plan view of the laminated body 20 and a perspective view of the laminated body 20 in one aspect of the laminated structure 10 according to the embodiment, respectively. As illustrated in FIGS. 3(a) and 3(b), in one aspect of the laminated structure 10, the laminated body 20 has a strip shape in plan view, and a pair of sides facing each other are long sides. Note that, in FIG. 3(b), the cutout (not illustrated) as illustrated in FIGS. 1 and 2 is formed on a side surface on a long side.

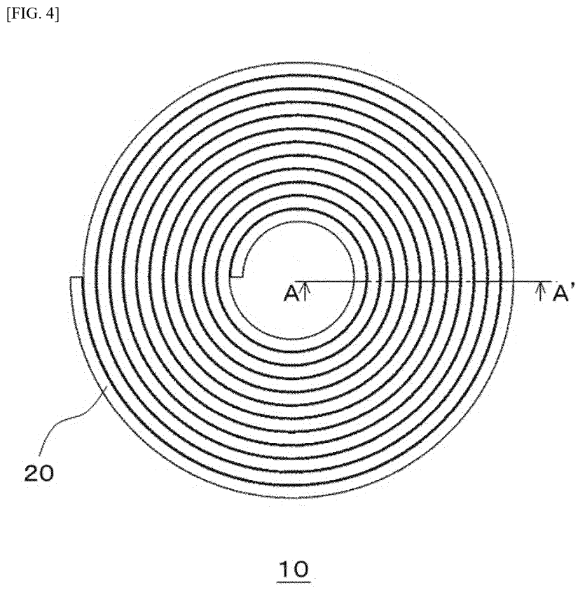

The laminated structure 10 may have a structure in which the plurality of separated laminated bodies 20 is laminated, or may have a coil-shaped structure in which a strip-shaped laminated body 20 is wound. FIG. 4 is a schematic view in a case where the laminated structure according to the embodiment has a coil-shaped structure although the cutout is omitted for easy understanding. In this case, a part of a cross section taken along line A-A′ illustrated in FIG. 4 has a laminated structure as illustrated in FIG. 1.

### (Method for Manufacturing Laminated Structure)

One aspect of a method for manufacturing a laminated structure according to the present embodiment includes: a laminated sheet production step of producing a laminated sheet by laminating an insulating layer on one main surface of a metal foil; a laminated body production step of producing a laminated body in which a cutout is formed at a laminated sheet cut end portion by cutting the laminated sheet using a cutting blade having a blade edge angle; and a laminated structure production step of producing a laminated structure by laminating the laminated body so that the metal foil and the insulating layer are staggered.

Hereinafter, the laminated sheet production step, the laminated body production step, and the laminated structure production step which are the method for manufacturing the laminated structure according to the present embodiment will be specifically described.

### (Laminated Sheet Production Step)

The laminated sheet production step is a step of producing a laminated sheet by laminating an insulating layer on one main surface of a metal foil.

A method for laminating the insulating layer on one main surface of the metal foil can be divided into two methods of a “method for directly producing an insulating main member” and a “laminating method using an adhesive layer which is an insulating layer constituting member”.

As the method for directly producing the insulating main member, a method for directly producing the insulating main member serving as an insulating layer by applying a coating material serving as the insulating main member (insulating layer) to one main surface of the metal foil using an existing coater or the like and drying the coating material, a method for directly laminating a film or a sheet-like insulating main member using an existing laminator or the like can be applied.

The laminating method using the adhesive layer which is the insulating layer constituent member will be described below.

First, an insulating main member is prepared. In a case of preparing the insulating main member, a method for forming the insulating main member by applying a coating material serving as the insulating main member to one main surface having peelability of a base member using an existing coater or the like and drying the coating material, a method for using a film or a sheet-like insulating layer, or the like can be applied.

Subsequently, an adhesive composition is applied to one main surface or both main surfaces of the insulating main member using an existing coater or the like and dried to form an adhesive layer. Subsequently, a method for laminating an adhesive layer side main surface of the insulating layer to one main surface of the metal foil using an existing laminator or the like can be applied.

A shape of the laminated sheet obtained in the laminated sheet production step is not particularly limited, and may be a strip shape.

(Laminated body Production Step)

The laminated body production step is a step of cutting a laminated sheet using a cutting blade having a blade edge angle to produce a laminated body in which a cutout is formed at a cut end portion of the laminated sheet.

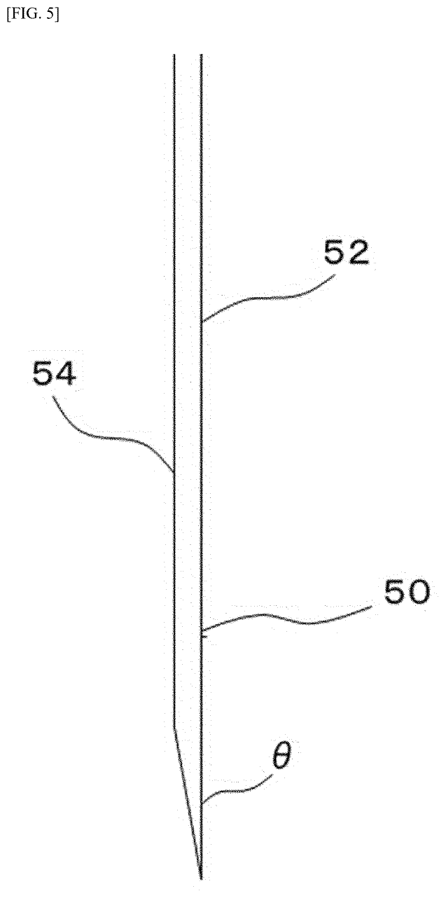

FIG. 5 is a schematic cross-sectional view of a cutting blade 50 used in the laminated body production step. One main surface of the cutting blade 50 is a blade angle non-surface 52, and another main surface of the cutting blade 50 is a blade angle surface 54.

A blade edge angle θ of the cutting blade 50 is an angle at which burrs are less likely to be generated at an end portion of the metal foil or the insulating layer and a cutout is generated at the time of cutting the laminated sheet, and is preferably 20° to 60°, more preferably 25° to 55°, and still more preferably 30° to 50°. When the blade edge angle θ is larger than 60°, the cutting blade 50 is less likely to enter the laminated sheet, and cutting cannot be performed well. Further, when the blade edge angle θ is smaller than 20°, not only the cutting blade 50 may be chipped, but also burrs may be easily generated.

Note that the cutting blade is not particularly limited, and may be a rotary blade or a fixed blade.

By changing the blade edge angle θ, a shape of the cutout, for example, the horizontal length H of the horizontal direction end region R1 and the vertical length V of the vertical direction end region R2 of a cutout S illustrated in FIG. 2 can be adjusted. Here, as for the length ratio (H/V) described above, when the blade edge angle θ of the cutting blade 50 decreases, the length H tends to decrease and the length V tends to increase, so that the length ratio (H/V) decreases. When the blade edge angle θ increases, the length H tends to increases and the length V tends to decrease, so that the length ratio (H/V) increases.

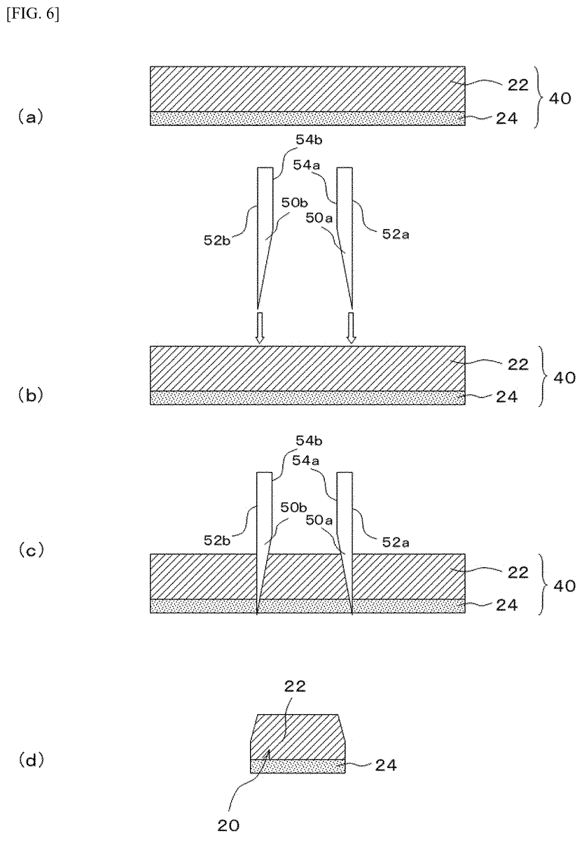

FIGS. 6(a) to 6(d) are schematic process diagrams showing the laminated body production step. Note that this drawing is an example illustrated for easy understanding of the process, and is a drawing in which two cutting blades are used to cut simultaneously. However, the number of cutting blades is not limited, and the cutting may be performed at a plurality of positions at the same time, may be performed at a plurality of different positions one by one in order, or may be performed at a plurality of positions of a laminated sheet 40 using one cutting blade.

First, as shown in FIG. 6(a), the laminated sheet 40 formed in a structure in which an insulating layer 24 is laminated on a metal foil 22 produced in the laminated sheet production step is fixed to a table or the like. A fixing method is not particularly limited, but a main surface of the metal foil 22 of the laminated sheet 40 is fixed so as to be the side with which the cutting blade comes into contact.

Next, as illustrated in FIG. 6(b), a cutting blade 50 (cutting blade 50a, cutting blade 50b) is installed above the laminated sheet 40. Specifically, the cutting blade 50 is positioned with reference to a blade angle non-surface 52 such that a blade angle surface 54 (blade angle surface 54a, blade angle surface 54b) of the cutting blade 50 faces a cut surface on a side to be a laminated body of the laminated sheet and a most distal end of a blade edge continuing from the blade angle non-surface 52 (blade angle non-surface 52a, blade angle non-surface 52b) is a cutout outermost portion of a desired laminated body.

Next, as shown in FIG. 6(c), the pair of cutting blades 50 (the cutting blade 50a and the cutting blade 50b) is pushed in the vertical direction from the main surface of the metal foil 22 of the laminated sheet 40 to cut the metal foil 22 and then the insulating layer 24, thereby obtaining a laminated body 20 having a cutout with a predetermined width as shown in FIG. 6(d).

Note that, in a case where cutting is performed at a plurality of positions of the laminated sheet 40 with one cutting blade, installation of the cutting blade 50 by positioning the cutting blade 50 with reference to the blade angle non-surface 52 may be repeated a plurality of times such that the most distal end of the blade edge continuing from the blade angle non-surface 52 is the desired cutout outermost portion.

A shape of the laminated body 20 obtained in the laminated body production step is not particularly limited, and may be, for example, a strip shape as shown in FIG. 3.

### Laminated Structure Production Step

The laminated structure production step is a step of producing a laminated structure by laminating a laminated body so that the metal foil and the insulating layer are staggered.

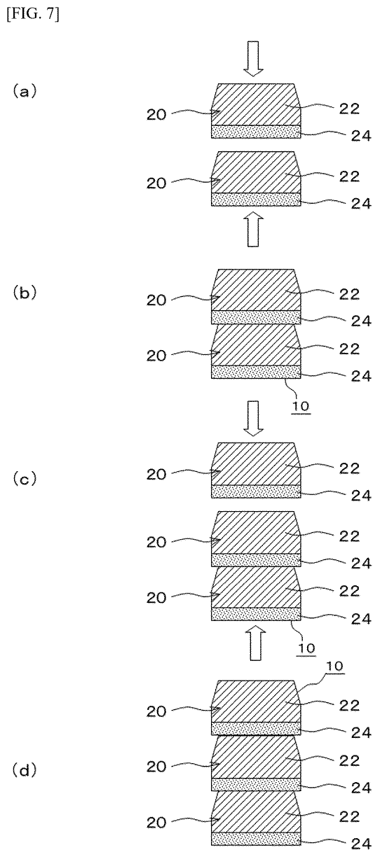

FIGS. 7(a) to 7(d) are schematic process diagrams showing a laminated structure production step.

As shown in FIG. 7(a), by laminating two laminated bodies 20 obtained in the laminated body production step such that the metal foil 22 and the insulating layer 24 are alternately arranged, a laminated structure 10 in which two laminated bodies 20 are laminated can be obtained (see FIG. 7(b)).

Further, as shown in FIG. 7(c), a third laminated body 20 is laminated on the laminated structure 10 shown in FIG. 7(b) so that the metal foil 22 and the insulating layer 24 are alternately arranged, whereby a laminated structure 10 in which three laminated bodies 20 are laminated can be obtained (see FIG. 7(d)).

By repeating the desired number of such laminations, it is possible to obtain a laminated structure 10 in which a desired number of laminated bodies 20 are laminated.

The laminating method is not particularly limited, and examples thereof include a “laminating method using an adhesive layer” and a “winding and laminating method”.

The laminating method using the adhesive layer can be divided into two.

The first is a method for obtaining the laminated structure 10 by alternately laminating the metal foil 22 and the insulating layer 24 by directly bonding an adhesive layer which is a constituent member of the above-described insulating layer 24 or laminating the adhesive layer using an existing laminator or the like.

The second is applied to a case where the insulating layer 24 does not have an exposable adhesive layer as a condition.

First, an adhesive composition of the same material as that of the adhesive layer which is a constituent member of the insulating layer 24 is applied to either the main surface of the metal foil 22 of the laminated body 20 or the exposed main surface of the insulating main member of the insulating layer using an existing coater or the like and dried to form an adhesive layer for lamination.

Subsequently, the laminated structure 10 is obtained by laminating the metal foil 22 and the insulating layer 24 alternately by, for example, directly bonding the adhesive layer for lamination or laminating the adhesive layer for lamination using an existing laminator or the like.

The winding and laminating method is applied when the laminated body 20 has a strip shape.

This is a method for obtaining a coil-shaped laminated structure 10 as shown in FIG. 4 by laminating the strip-shaped laminated body 20 obtained in the laminated body production step while winding.

A cross section in the main surface vertical direction of the laminated structure 10 obtained by the laminating method using the adhesive layer and a part of a cross section of the laminated structure 10 obtained by the winding and laminating method taken along line A-A′ illustrated in FIG. 4 have a laminated structure as illustrated in FIG. 1.

In addition, in the laminated structure 10 obtained by the winding and laminating method, the metal foil 22 and the insulating layer 24 included in the laminated body 20 constituting the laminated structure 10 are physically continuous, and the metal foils 22 are electrically connected to each other.

### EXAMPLES

Next, the embodiments of the present invention will be described in more detail based on specific examples.

### (Production of Adhesive Layer)

An acrylic pressure-sensitive adhesive coating was applied to a main surface of a peeling-treated PET film 1 so as to have a thickness of 2.5 μm and dried, and then the applied main surface was covered with a peeling-treated PET film 2 having a peel strength weaker than that of the PET film 1 to obtain an adhesive layer with a double-sided PET film. A thickness of the adhesive layer was 2.5 μm.

### (Production of Insulating Layer)

The PET film 2 of the produced adhesive layer with the double-sided PET film was peeled off, and then a polyimide film (Kapton 20 EN manufactured by DU PONT-TORAY CO., LTD.) having a thickness of 5 μm was bonded to obtain an insulating layer with a single-sided PET film having a configuration of “PET film 1/adhesive layer/polyimide film”.

### (Production of Laminated Sheets A to D)

The PET film 1 of the produced insulating layer with the single-sided PET film was peeled off, and four types of rolled copper foils having different thicknesses were bonded to an exposed main surface of the adhesive layer to obtain four types of laminated sheets A to D having a configuration of “rolled copper foil/adhesive layer/polyimide film”. A thickness of the rolled copper foil used was shown in Table 1.

TABLE 1

| | THICKNESS OF |
|---|---|
| LAMINATED SHEET | ROLLED COPPER FOIL |
| REFERENCE NUMERAL | (μm) |
| A | 10 |
| B | 50 |
| C | 70 |
| D | 100 |

### (Production of Laminated Body)

The produced laminated sheets A to D were cut so as to have a main surface of 50 mm×50 mm, and then each of the laminated sheets A to D was cut by being pressed into two places on a main surface of the rolled copper foil from a vertical direction using each rotary blade (outer diameter: 100 mm, SKH material) having seven types of blade edge angles, thereby obtaining each laminated body having cutouts at both end portions of the metal foil of the cut surface on a side to be a laminated body of the laminated sheet.

At this time, only one type of rotary blade was used for producing one laminated body.

In addition, each laminated body was cut by adjusting a width of the polyimide film in the cross section (width in a direction parallel to a main surface of the laminated body) to 20 mm. Specifically, in order to perform positioning with reference to a blade angle non-surface such that a blade angle surface of the rotary blade faces the cut surface on the side to be the laminated body of the laminated sheet and a most distal end of a blade edge continuing from the blade angle non-surface is a cutout outermost portion of the desired laminated body, two positions of 15 mm from both end sides in a width direction parallel to the main surface were used for positioning of the rotary blade on a surface that is not the main surface of one side of each of the laminated sheets A to D.

Furthermore, five laminated bodies were produced for each laminated body to form a laminated structure later.

For each of the produced laminated bodies, a horizontal length H of a horizontal direction end region R1 and a vertical length V of a vertical direction end region R2 were measured using an optical microscope, and then a length ratio (H/V) was calculated for each of the laminated bodies. The horizontal length H of the horizontal direction end region R1 and the vertical length V of the vertical direction end region R2, and the length ratio (H/V) with respect to the blade edge angle of each laminated body were summarized and shown in Tables 2 and 3, respectively.

TABLE 2

| LAMINATED | | | | | | | | | | | | | | |
|---|---|---|---|---|---|---|---|---|---|---|---|---|---|---|
| SHEET | BLADE EDGE ANGLE (°) | | | | | | | | | | | | | |
| REFERENCE | 10 | | 20 | | 30 | | 40 | | 50 | | 60 | | 70 | |
| NUMERAL | H | V | H | V | H | V | H | V | H | V | H | V | H | V |
| A | 1.8 | 9.2 | 3.7 | 8 | 5.9 | 6.9 | 8.6 | 5.9 | 12.2 | 4.6 | 17.8 | 3.5 | 28.2 | 2.3 |
| B | 8.8 | 46 | 18.6 | 40.2 | 29.6 | 34.3 | 43 | 29.3 | 61.2 | 22.9 | 88.9 | 17.4 | 140.8 | 11.7 |
| C | 12 | 64.3 | 25.4 | 56.3 | 40.4 | 48 | 58.7 | 41 | 83.4 | 32 | 121.2 | 24.3 | 192 | 16.3 |
| D | 17.6 | 91.9 | 37.3 | 80.6 | 59.3 | 68.6 | 86.1 | 58.6 | 122.3 | 45.7 | 177.8 | 34.8 | 281.6 | 23.3 |

TABLE 3

| LAMINATED | | | | | | | |
|---|---|---|---|---|---|---|---|
| SHEET | BLADE EDGE ANGLE(°) | | | | | | |
| REFERENCE | 10 | 20 | 30 | 40 | 50 | 60 | 70 |
| NUMERAL | H/V | H/V | H/V | H/V | H/V | H/V | H/V |
| A | 0.2 | 0.5 | 0.9 | 1.5 | 2.7 | 5.1 | 12.1 |
| B | 0.2 | 0.5 | 0.9 | 1.5 | 2.7 | 5.1 | 12.1 |
| C | 0.2 | 0.5 | 0.8 | 1.4 | 2.7 | 5 | 11.8 |
| D | 0.2 | 0.5 | 0.9 | 1.5 | 2.7 | 5.1 | 12.1 |

Furthermore, among the obtained laminated bodies, burrs were generated on the cut surfaces of all the laminated bodies obtained by cutting at a blade edge angle of 10° with the rotary blade.

In addition, in all the laminated bodies obtained by cutting at the blade edge angle of 70° with the rotary blade, deformation of a cutout shape due to the cutting blade hardly entering the laminated sheet was confirmed, and the desired cutout shape was not obtained.

### (Production of Laminated Structure)

For each type of the produced laminated bodies, five laminated bodies (referred to as laminated bodies 1 to 5) were repeatedly laminated so that an insulating layer as a constituent member of the laminated body 2 was first laminated directly on a metal foil as a constituent member of the laminated body 1, an insulating layer as a constituent member of the laminated body 3 was subsequently laminated directly on a metal foil as a constituent member of the laminated body 2, to produce each of the laminated structures in which five laminated bodies were laminated.

Among the obtained laminated structures, each of the laminated structures produced with the rotary blade having the blade edge angles of 20°, 30°, 40°, 50°, and 60° had no burr at cut surfaces of the five laminated bodies constituting each of the laminated structures and had a desired cutout shape, and thus a problem of a short circuit caused by a cut surface shape between the adjacent metal foils via the insulating layer was not confirmed.

On the other hand, in each of the laminated structures produced with the rotary blade having the blade edge angle of 10°, burrs were confirmed on the cut surfaces of the five laminated bodies constituting each of the laminated structures, and thus a problem of a short circuit due to the cut surface shape between the adjacent metal foils via the insulating layer was confirmed.

Further, in each of the laminated structures produced with the rotary blade having the blade edge angle of 70°, deformation was confirmed in a cutout shape of the five laminated bodies constituting each of the laminated structures, and thus a problem of a short circuit due to the cut surface shape between the adjacent metal foils via the insulating layer was confirmed.

### (Use of Laminated Structure)

The laminated structure 10 according to the present embodiment is suitably used for electronic devices. In particular, the coil-shaped laminated structure 10 is used as a laminated coil for a noise filter such as a low-pass filter or a high-pass filter.

In recent years, the laminated coil has been required to be further thinned, and operation reliability of the noise filter can be improved by suppressing an electrical short circuit by applying the laminated structure 10 according to the present embodiment.

Although the embodiments of the present invention have been described above, these are examples of the present invention, and various configurations other than the above can be adopted.

### REFERENCE SIGNS LIST

10 Laminated structure
20 (20A, 20B) Laminated body
22 (22a, 22b) Metal foil
24 (24a, 24b) Insulating layer

1. A laminated structure in which two or more layers of a laminated body are laminated, wherein
the laminated body includes a metal foil and an insulating layer laminated on one main surface of the metal foil,
the metal foil and the insulating layer are alternately laminated in the laminated structure, and
assuming that adjacent laminated bodies constituting the laminated structure are a laminated body A and a laminated body B in order from a lower portion to an upper portion, the laminated body A has an insulating layer a located at the lower portion and a metal foil a located at the upper portion, and the laminated body B has an insulating layer b located at the lower portion and a metal foil b located at the upper portion,
a cutout is formed at least at one end portion of the laminated body A.

2. The laminated structure according to claim 1, wherein a length ratio that is a ratio of a horizontal length of a horizontal direction end region to a vertical length of a vertical direction end region of the cutout is 0.4 to 10.

3. The laminated structure according to claim 2, wherein the horizontal length of the horizontal direction end region is 1 μm to 200 μm, and the vertical length of the vertical direction end region is 1 μm to 400 μm.

4. The laminated structure according to claim 1, wherein the cutout is formed only in the metal foil a.

5. The laminated structure according to claim 1, wherein the cutout is formed in the metal foil a and the insulating layer a.

6. The laminated structure according to claim 1, wherein the laminated body has a strip shape.

7. The laminated structure according to claim 6, wherein a coil shape in which the laminated body is wound is provided.

8. The laminated structure according to claim 7, wherein the laminated structure is used for a noise filter.

9. A method for manufacturing a laminated structure, comprising:
a laminated sheet production step of producing a laminated sheet by laminating an insulating layer on one main surface of a metal foil;
a laminated body production step of producing a laminated body in which a cutout is formed at a laminated sheet cut end portion by cutting the laminated sheet using a cutting blade having a blade edge angle of 20° to 60°; and
a laminated structure production step of producing a laminated structure by laminating the laminated body such that the metal foil and the insulating layer are staggered.

10. The method for manufacturing the laminated structure according to claim 9, wherein
the laminated body has a strip shape, and
the laminated body is laminated while being wound in the laminated structure production step.
